(19) United States
(12) Patent Application Publication
(10) Pub. No.: US 2011/0303716 A1
(43) Pub. Date: Dec. 15, 2011

(54) APPARATUS FOR BREAKING OFF THE HEAD OF A GLASS AMPOULE

(76) Inventor: Cezary Pluska, Kiel (DE)

(21) Appl. No.: 13/203,054

(22) PCT Filed: Feb. 27, 2010
(86) PCT No.: PCT/DE10/00224

§ 371 Date: Aug. 24, 2011

(30) Foreign Application Priority Data
Mar. 3, 2009 (DE) 20 2009 003 024.5
May 19, 2009 (DE) 20 2009 007 161.8

(51) Int. Cl. B67B 7/92

(52) U.S. Cl. 225/103

(57) ABSTRACT

An apparatus for breaking off the head of a glass ampoule that is composed of a cylindrical body, a neck forming a predetermined breaking point and a head, comprising an incline A extending in an inclined manner to the axis of the ampoule to be inserted toward the same, wherein a first support surface (C) is disposed on the side of the incline (A) causing a break-off of the head in the region above the bottom of the ampoule to be inserted at a radius of the ampoule from the axis of the apparatus and a second support surface (B) is disposed on the opposite side beneath the neck of the ampoule (inserted in the apparatus) at a distance from the axis of the apparatus that corresponds to the radius of the ampoule, wherein during a relative movement of the apparatus to the ampoule in the direction of the axis thereof the incline (A) breaks off the head at the neck.

The invention relates to an apparatus for breaking off the head of a glass ampoule that is composed of a cylindrical body, a neck forming a predetermined breaking point and a head, comprising an ampoule holder and an incline extending in an inclined manner to the axis of the ampoule.

An apparatus of this type is known from EP 0 926 900 B1. In this known apparatus the incline forms a separate body that can be moved relative to the ampoule. This apparatus is quite complex.

The invention is therefore based on the object of producing an apparatus for breaking off the head of an ampoule that has a very simple design and can therefore be produced cost-effectively.

According to the invention this object is achieved by a first support surface (C) disposed on the side of the incline (A) causing a break-off of the head in the region above the bottom of the ampoule to be inserted at a radius of the ampoule from the axis of the apparatus and a second support surface (B) is disposed on the opposite side beneath the neck of the ampoule (inserted in the apparatus) at a distance from the axis of the apparatus that corresponds to the radius of the ampoule, wherein during a relative movement of the apparatus to the ampoule in the direction of the axis thereof the incline (A) breaks off the head at the neck.

A preferred exemplary embodiment is characterized by a spring element that is arranged in the area of the incline opposite thereto and at a distance therefrom that is smaller than the inside diameter of the head and that holds the broken-off head until the tip thereof is acted on manually.

The invention is explained using a drawing.

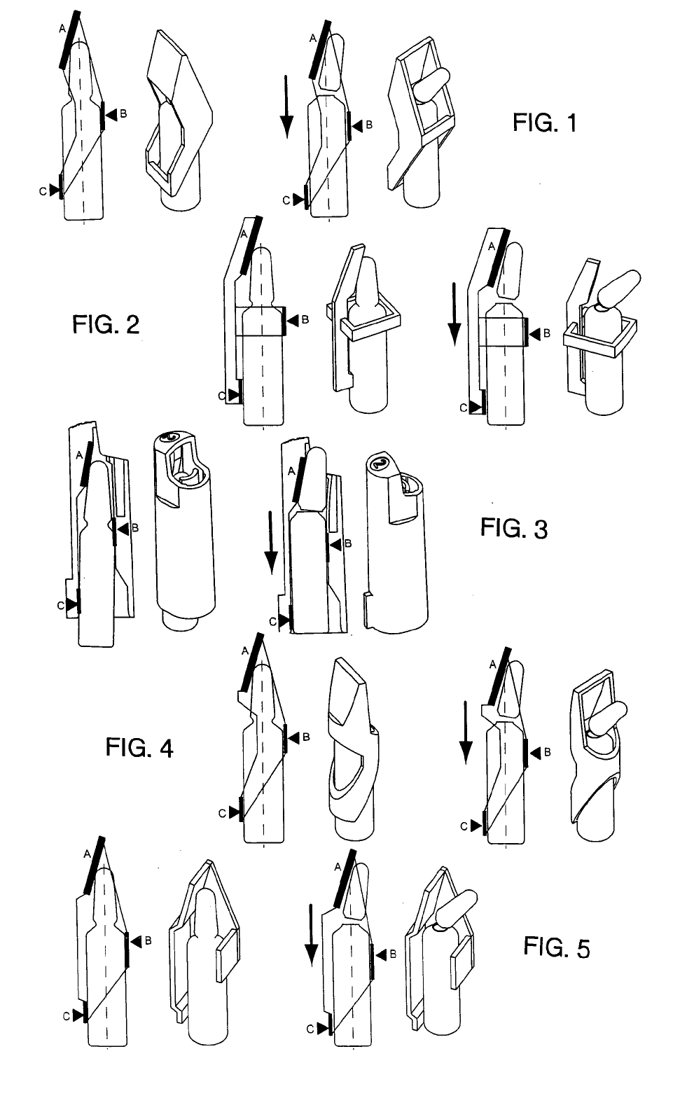

FIG. 1 shows a first exemplary embodiment of the invention,

FIG. 2 shows a second exemplary embodiment of the invention,

FIG. 3 shows a third exemplary embodiment of the invention,

FIG. 4 shows a fourth exemplary embodiment of the invention, and

FIG. 5 shows a fifth exemplary embodiment of the invention,

the figures each representing a schematic diagram and a perspective view of the ampoule before the head is broken off (1st figure) and after the head has been broken off (2^{nd} figure).

In all its exemplary embodiments, the apparatus has an incline A that projects in an inclined manner relative to the axis of the ampoule inserted into the apparatus. Here the incline A forms a support surface that breaks off the head of the ampoule at its neck in the case of a relative movement of the apparatus in the direction of the axis of the ampoule. To absorb the forces occurring in the process the apparatus has a first support surface C that is arranged on the same side of the longitudinal axis of the apparatus as the incline A bordering on the bottom of the ampoule (inserted into the apparatus from below), and a second support surface B disposed on the opposite side below the neck of the ampoule inserted into the apparatus. When the apparatus is pushed onto the ampoule (or when the ampoule is pushed into the apparatus) the head of the ampoule is broken off by the incline A at the head that forms a predetermined breaking point. The inside distance of the support surfaces B and C from each other here corresponds to the thickness of the ampoule that is to be received, it can be pushed into the apparatus in the direction of the axis thereof such that its axis corresponds to the axis of the apparatus.

In the exemplary embodiment shown in FIG. 1 the apparatus is designed like a rocker, in the exemplary embodiment shown in FIG. 2 the incline A and the support surface C are elements of a strip against which a frame is placed that grips around the ampoule on being pushed into the apparatus.

In the exemplary embodiment according to FIG. 3 the apparatus is provided with a spring element that is disposed opposite the incline A, the distance of the spring element from the incline A being smaller than the inside diameter of the head. The spring element will firmly hold the head after being broken off until its tip is acted on manually and the head is released.

In the exemplary embodiment according to FIG. 4 the apparatus is of an essentially cylindrical design (that is except the incline A).

In the exemplary embodiment according to FIG. 5 the apparatus with an essentially stretched element forming the incline A and the support surface C is shaped a side surface that forms the support surface B on its free side.

1. An apparatus for breaking off the head of a glass ampoule that is composed of a cylindrical body, a neck forming a predetermined breaking point and a head, comprising an incline A extending in an inclined manner to the axis of the ampoule to be inserted toward the same, characterized by a first support surface (C) disposed on the side of the incline (A) causing a break-off of the head in the region above the bottom of the ampoule to be inserted at a radius of the ampoule from the axis of the apparatus and a second support surface (B) disposed on the opposite side beneath the neck of the ampoule (inserted in the apparatus) at a distance from the axis of the apparatus that corresponds to the radius of the ampoule, wherein during a relative movement of the apparatus to the ampoule in the direction of the axis thereof the incline (A) breaks off the head at the neck.

2. The apparatus according to claim 1, characterized by a spring element that is arranged in the area of the incline (A) opposite thereto and at a distance therefrom that is smaller than the inside diameter of the head and that holds the broken-off head until the tip thereof is acted on manually.
